(19) United States
(12) Patent Application Publication
(10) Pub. No.: US 2008/0239037 A1
(43) Pub. Date: Oct. 2, 2008

(54) INK TANK AND METHOD FOR MANUFACTURING THE SAME

(75) Inventors: Ryoji Inoue, Kawasaki-shi (JP); Yasuo Kotaki, Yokohama-shi (JP); Tetsuya Ohashi, Matsudo-shi (JP); Hitoshi Takada, Yokohama-shi (JP); Hideki Ogura, Yokohama-shi (JP); Kouichi Kubo, Yokohama-shi (JP); Tatsuo Nanjo, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/057,110

(22) Filed: Mar. 27, 2008

(30) Foreign Application Priority Data
Mar. 30, 2007 (JP) 2007-092028

(51) Int. Cl. B41J 2/175

(52) U.S. Cl. 347/86; 29/890.1

(57) ABSTRACT

An ink tank includes an ink containing chamber configured to directly contain ink, a supply port configured to supply the ink from the ink containing chamber to a recording head, a capillary member disposed in the supply port to hold the ink, and a sealing member configured to cover the supply port. An air volume (V) of a space constituted by the capillary member and the sealing member, an ink volume (Vi) held by the capillary member, and a maximum volume (Vexp) when air expands in the space accompanying environmental fluctuation of the ink tank, satisfy Vi≧Vexp−V.

### BACKGROUND OF THE INVENTION

1. Field of the Invention

The present invention relates to an ink tank installed and used in an ink jet recording apparatus, and its manufacturing method.

2. Description of the Related Art

Conventionally, an ink jet recording head for discharging ink to carry out recording, and an ink tank for holding and supplying ink to the recording head can be roughly classified into the following two types: a head-integrated ink cartridge in which the recording head and the ink tank are integrated, and a replaceable ink cartridge in which the recording head and the ink tank are detachable from each other. In the case of the replaceable ink cartridge, when there is no more ink in the ink tank, the cartridge can still be used by replacing only the ink tank. Thus, the replaceable ink cartridge is generally advantageous in running costs.

For the replaceable ink cartridge of this type, some configurations have been devised to prevent ink leakage at an ink supply port when the ink tank is dealt with as a single unit (e.g., in a distribution process).

Regarding a tank in which a porous body occupying the entire interior of the ink tank holds ink, a method that seals an opening for supplying ink to a recording head with a flexible seal has been discussed in U.S. Pat. No. 5,701,995. Similarly, regarding a tank in which an absorber occupying the entire interior of the tank holds ink, a method that seals an opening for supplying ink to a head with a cap and an elastic seal is discussed in Japanese Patent Application Laid-Open No. 08-112915. Known is an ink tank having an ink tank casing divided into two chambers. The first chamber is an ink chamber holding ink, and the other chamber communicates with the first chamber and contains an absorber. The ink tank supplies ink to a head via the absorber. A method of sealing an ink supply port of this ink tank is discussed in Japanese Patent Application Laid-Open No. 8-025644. Further, regarding a tank that includes a plurality of absorbers at different positions in the ink tank and supplies ink to a head via the absorbers, a method of sealing ink supply ports is discussed in Japanese Patent Application Laid-Open No. 10-128990. All of these ink tanks are configured to hold the ink by the absorbers occupying major parts inside the casings.

Recently, to carry out high-speed printing of a great deal of data, there is an increasing tendency to consume a greater amount of ink. To increase the amount of ink held in an ink tank so that depletion of ink while making prints can be prevented, an ink tank is available that directly stores ink without any porous body disposed in the tank. However, if such an ink tank is configured to seal an ink supply port with a seal member as in the conventional case, a temperature change or a pressure change during tank transportation or delivery may cause ink to flow out through the ink supply port. For this type of ink tank, as compared with the ink tank that includes the porous body occupying the major part of the tank and holds the ink in the porous body, the amount of ink held in the tank is greater. As a result, when the seal member or the cap is removed when the ink tank is used, the ink can be scattered. The flow of ink into a space of the ink supply port caused by a change of an external environment such as a temperature or atmospheric pressure will more specifically be described below referring to FIGS. 7A to 7D. FIG. 7A is an enlarged sectional diagram illustrating the vicinity of an ink supply port 1014. An ink containing chamber 1101 occupying a major part inside the ink tank includes no porous body and directly contains ink.

An opening of the ink supply port 1014 is sealed with a sealing member 1017. A meniscus forming member 1016 is disposed so as to prevent ink leakage through the ink supply port 1014. The meniscus forming member 1016 and the sealing member 1017 constitute a sealed supply port space 1100. As apparent from FIG. 7A, a wall surface of the supply port space 1100 is a slope and formed to reduce a space volume. An ink supply member 1013 includes a member such as a sponge that is disposed in a side bottom surface of the ink supply port 1014 of the ink containing chamber 1101 to easily hold ink. Ink is supplied so as not to destroy the meniscus of the meniscus forming member 1016 even when the remaining amount of ink in the ink containing chamber 1101 is small or a posture of the ink tank is changed. When there is a sufficient amount of ink, the ink is directly held in the ink containing chamber 1101. In this case, the meniscus of the ink is formed by interaction between the ink supply member 1013, which is a first meniscus forming member, and the second meniscus forming member 1016.

FIG. 7B illustrates a case where the ink supply port 1014 is set downward in a vertical direction (gravitational direction) from the state of FIG. 7A and an environmental temperature increases. The supply port space 1100 is sealed. An atmosphere communicating port (not illustrated) is disposed on an upstream side of the ink containing chamber 1101, and the ink can be moved in the upstream direction. When the environmental temperature increases, air of the supply port space 1100 expands. The expanded air flows in an arrow direction of FIG. 7B to destroy the meniscus formed in the second meniscus forming member 1016 and enters the ink supply member 1013. The air, which has expanded too much to be held in the ink supply member 1013, flows over the ink supply member 1013 to enter the ink containing chamber 1101 as a bubble 1102, and moves upward in the vertical direction in the ink containing chamber 1101. The ink moves by an amount equal to a volume of the expanded air to the atmosphere communicating port side.

FIG. 7C illustrates a case where the ink holding state of the meniscus forming member 1016 destroyed in FIG. 7B is changed to an equilibrium state. As illustrated in FIG. 7B, the air expansion in the supply port space 1100 destroys the ink holding state of the meniscus forming member 1016. Ink pressure of the meniscus portion holding negative pressure before the destruction, becomes 1 atm. pressure, which is equal to outside air, and a fiber of the meniscus forming member 1016 are set in an equilibrium state as illustrated in FIG. 7C. The second meniscus forming member 1016 is formed so that its capillary force can be larger than that of the ink supply member 1013 serving as the first meniscus forming member. Accordingly, as indicated by an arrow of FIG. 7C, the ink enters from the vicinity of an end of the meniscus forming member 1016. A reason for the entry of the ink from the end is that fibers of the two meniscus forming members (1013 and 1016) are brought into direct contact with each other at the ends. Further, the fibers of the two meniscus forming members are in contact with each other via the expanded air in the center of the fibers. The ink enters to fill the second meniscus forming member 1016, thereby forming a meniscus again. As illustrated in FIG. 7C, a bubble 1103 in the ink supply member 1013 and a bubble in the ink containing chamber 1101 are separated from air in the supply port space 1100.

FIG. 7D illustrates a state where an environmental change reduces an ambient temperature from the state of FIG. 7C to restore the same temperature as that of FIG. 7A. The reduced temperature causes volume shrinkage of the air in the supply port space 1100 and the bubble 1103 in the ink supply member 1013. The air of the supply port space 1100 and the air of the ink supply member 1013 individually shrink as they are separated from each other by the meniscus of the second meniscus forming member 1016. The bubble 1103 shrinks in the ink supply member 1013 to become a residual bubble. When the air in the supply port space 1100 shrinks, the ink is drawn from the meniscus forming member 1016 and leaks as an ink 1104 to the sealing member 1017. In this case, the bubble 1013 hardly moves into the supply port space 1100. In order to move air through the meniscus forming member 1016 filled with the ink, the air has to destroy surface tension of the ink generated in the meniscus forming member 1016. On the other hand, in order to move the ink through the meniscus forming member 1016 filled with the ink, such a force is unnecessary since the ink is present inside and outside the meniscus forming member 1016. In other words, when the air moves in the meniscus forming member 1016, flow resistance increases by an amount equal to the surface tension of the ink. However, when the ink moves, flow resistance is small. Bubbles which have moved into the ink containing chamber 1101 that directly contains the ink does not return to the supply port space 1100 since the bubbles are completely separated from the outside.

When the environmental temperature increases again from the state of FIG. 7D, the states of FIGS. 7B to 7D are similarly repeated to increase the amount of leaked ink 1104. Through repetition of this cycle, the supply port space 1100 is almost filled with the ink 1104 at the end, and the air initially present in the supply port space 1100 moves as a bubble in the ink supply member 1013 or the ink containing chamber 1101. Therefore, a possibility of ink scattering when peeling off the sealing member 1017 increases. According to the configurations of FIGS. 7A to 7C, the wall surface of the ink supply port 1014 is slanted so that the volume of the supply port space 1100 is reduced and the ink supply port 1014 is sealed with the sealing member 1017. Owing to the small space volume, the amount of liquid leakage in the supply port space 1100 is decreased, which reduces ink scattering during unsealing. FIG. 8 is an enlarged diagram of the ink supply port portion. In the ink tank of FIG. 8, the supply port space 1100 is narrow, and the supply port is sealed at two places A and B with steps formed there. The sealing member 1017 is stuck to the ink supply port portion as indicated by a dotted line 1019. Thus, by forming the step at the ink supply port exit and sealing the ink supply port at the two places, a place is provided to retain the ink in a boundary portion 1018 of the step at the time of breaking the sealing member. When the sealing member is broken, ink leaked from the supply port space can partly be retained at the step portion 1018. However, the step formed in a tip shape of the ink supply port shows a complex configuration in terms of manufacturing, and the sealing with the sealing member at the two places also requires a complex process. In addition, while the leaked ink can partly be retained at the step portion 1018, its effect is not always satisfactory.

In the ink tank having been subjected to the temperature change cycle, bubbles are deposited within the ink supply member 1013. Since these bubbles are never discharged by themselves, the bubbles constitute resistance when ink is supplied to the recording head. As a result, the amount of ink supplied from the ink tank to the head runs short, which causes a printing failure or ink use efficiency in the ink tank tends to decline.

A similar problem occurs in the ink tank which holds the ink by the ink containing member including a sponge as discussed in U.S. Pat. No. 5,701,995 or Japanese Patent Application No. 08-112915. In such an ink tank, when the increase of an ambient temperature expands air in the supply port space, the expanded air never moves greatly from the vicinity of the supply port. However, when the ink containing member (porous member) occupying the major part in the tank includes a capillary member such as a sponge, it is difficult to completely remove air from the ink containing member. The air in the ink containing member expands, so that the ink in the ink containing member may be pushed to the ink supply port side, causing ink leakage from the vicinity of the supply port. The larger the ink containing member, the greater an amount of residual air in the ink containing member, which increases ink leakage to the ink supply port.

An ink tank is available, which is provided with an ink containing member including only a capillary member in an ink containing chamber in the tank, and which supports the ink containing member by a rib in a tank inner wall. In such an ink tank, a space is generated between the capillary member and the tank inner wall rib. An ink supply port is not sealed as it communicates with the space, and thus a problem that ink leaked to the supply port space is retained, does not occur. However, in the thus configured tank, since the ink is held by the ink containing member disposed in the ink containing chamber, therefore the amount of ink which can be held is small for a volume of the tank, which causes enlarging of the ink tank.

### SUMMARY OF THE INVENTION

The present invention is directed to an ink tank which can reduce the amount of ink leaked into an ink supply port and suppress ink scattering when breaking a seal of the ink tank.

According to an aspect of the present invention, an ink tank includes an ink containing chamber configured to directly contain ink, a supply port configured to supply the ink from the ink containing chamber to a recording head, a capillary member disposed in the supply port to hold the ink, and a sealing member configured to cover the supply port. An air volume (V) of a space constituted by the capillary member and the sealing member, an ink volume (Vi) held by the capillary member, and a maximum volume (Vexp) when air expands in the space accompanying environmental fluctuation of the ink tank, satisfy Vi≧Vexp−V.

According to another aspect of the present invention, an ink tank includes an ink containing chamber configured to directly contain ink, a supply port configured to supply the ink from the ink containing chamber to a recording head, a capillary member disposed in the supply port to hold the ink, and a sealing member configured to cover the supply port. An air volume (Vb) of a space constituted by the capillary member and the sealing member, an air volume (Va) held by the capillary member, and a minimum air volume (Vshr) when air shrinks in the space accompanying environmental fluctuation of the ink tank, satisfy the following condition, when the sealing member is in contact with the supply port:

Va≧Vb−Vshr.

According to yet another aspect of the present invention, a method for manufacturing an ink tank which includes an ink containing chamber configured to directly contain ink, a supply port configured to supply the ink from the ink containing chamber to a recording head, a capillary member disposed in the supply port to hold the ink, and a sealing member configured to cover the supply port, includes covering the supply port with the sealing member under an environment of pressure higher than 1 atm, in a manner that an air volume (V) of a space constituted by the capillary member and the sealing member, an ink volume (Vi) held by the capillary member, and a maximum volume (Vexp) when air expands in the space accompanying environmental fluctuation of the ink tank, satisfy the following conditions: Vi≧Vexp−V, alternatively, in a manner that an air volume (Vb) of a space constituted by the capillary member and the sealing member, an air volume (Va) held by the capillary member, and a minimum air volume (Vshr) when air shrinks in the space accompanying environmental fluctuation of the ink tank, satisfy the following condition, when the sealing member is in contact with the supply port:

Va≧Vb−Vshr.

According to the exemplary embodiments of the present invention, ink leakage to the supply port space caused by a temperature change or a pressure change likely to occur during ink tank transportation can be suppressed, and ink scattering when a user opens the cap member can be reduced.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a sectional diagram of an ink tank according to a first exemplary embodiment of the present invention.

FIG. 2 is an external perspective diagram of the ink tank of the first exemplary embodiment.

FIG. 3 is an exploded perspective diagram of the ink tank of the first exemplary embodiment.

FIG. 4A is a sectional diagram cut on the line 4A-4A of the ink tank of the first exemplary embodiment.

FIG. 4B is a sectional diagram illustrating a state of an expanded air in a supply port space from a state of FIG. 4A.

FIG. 4C is a sectional diagram illustrating a state of shrunk air in the supply port space from the state of FIG. 4B.

FIG. 5A is a sectional diagram illustrating an operation of fixing a cap member to a supply port of the tank according to the first exemplary embodiment.

FIG. 5B is a sectional diagram illustrating a fixed state of the cap member of FIG. 5A.

FIG. 5C is a sectional diagram illustrating a state of shrunk air in the supply port space from the state of FIG. 5B.

FIG. 5D is a diagram illustrating an air volume Va held in a capillary member.

FIG. 6 is a sectional diagram of an ink tank according to a second exemplary embodiment of the present invention.

FIG. 7A is a sectional diagram of a conventional ink tank.

FIG. 7B is a sectional diagram illustrating a state of expanded air in a supply port space in the conventional ink tank.

FIG. 7C is a sectional diagram illustrating the air in a fiber equilibrium state in the conventional ink tank.

FIG. 7D is a sectional diagram illustrating a state of shrunk air in the supply port space in the conventional ink tank.

FIG. 8 is an enlarged diagram of the vicinity of a supply port in the conventional ink tank.

### DETAILED DESCRIPTION OF THE EMBODIMENTS

Various exemplary embodiments, features, and aspects of the invention will be described in detail below with reference to the drawings.

### First Exemplary Embodiment

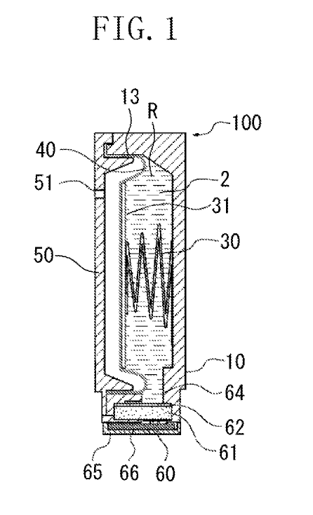

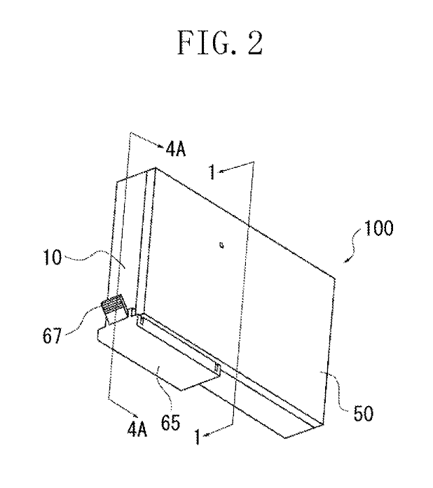

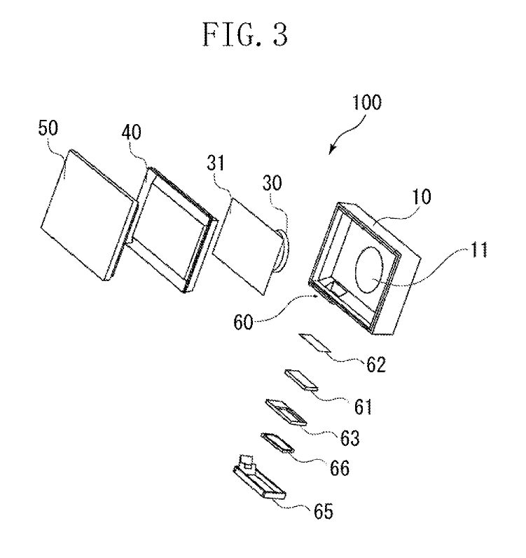

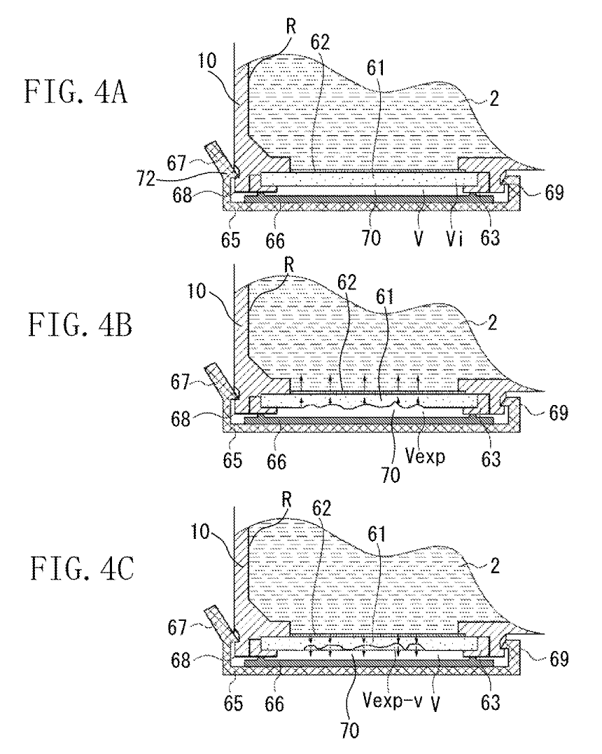

FIG. 1 is a sectional diagram of an ink tank 100 according to a first exemplary embodiment of the present invention. FIG. 2 is a perspective diagram of the ink tank 100. FIG. 1 corresponds to a sectional diagram cut on the line I-I of FIG. 2. FIG. 3 is an exploded perspective diagram of the ink tank 100. Each of FIGS. 4A to 4C corresponds to a sectional diagram cut on the line 4A-4A of FIG. 2.

### (Configuration of Ink Tank)

The ink tank 100 is a container for containing ink 2 in an ink containing chamber R which includes a tank case 10 and a flexible member 40. An ink guide port 64 disposed in the ink containing chamber R communicates with an ink supply port 60. The ink supply port 60 is connected to an ink supply path of an ink jet recording head. When the ink tank 100 is transported/delivered, in order to prevent ink leakage from the ink supply port 60, the ink supply port 60 is sealed with a cap member 65 having a sealing member 66 attached thereto. The sealing member 66 is an elastic member made of an elastic material such as rubber. When the ink tank 100 is attached to the ink jet recording head, the ink tank 100 is fixed after removing the cap member 65 from the ink tank 100. The ink tank 100 can be separated from the recording head.

As illustrated in FIG. 3, the ink tank 100 mainly includes the tank case 10, a spring member 30, a pressure plate 31, the flexible member 40, and a cap member 50. Around the ink supply port 60, the ink tank 100 includes a capillary member 61, a meniscus holding member 62, a supply port member 63, a sealing member 66, and the cap member 65. The tank case 10, the cap member 50, and the supply port member 63 constitute a casing of the ink tank 100.

In the tank case 10, the ink supply port 60 is formed for connection to the ink jet recording head. As illustrated in FIG. 1, the ink supply port 60 includes the capillary member 61 and the meniscus holding member 62. The capillary member 61 is made of a material of certain flexibility to absorb positional shifting of the recording head in a vertical direction (up-and-down direction of FIG. 1) when the recording head is connected to the ink supply port 60. The capillary member 61 is provided with a capillary force to constitute an ink flow path. To prevent ink leakage from the ink supply port caused by vibration or falling during transportation or delivery of the ink tank 100, the ink supply port 60 is sealed with the sealing member 66. The ink containing chamber R is maintained at negative pressure to prevent dripping of the ink from the ink supply port 60 in a stationary state. The meniscus holding member 62 generates an ink meniscus to prevent drawing-in of bubbles from the ink supply port 60 by the negative pressure in the ink containing chamber R. Thus, as the meniscus holding member 62, a member for generating meniscus holding pressure that is higher than a maximum value of the negative pressure generated in the ink containing chamber R, is selected.

The spring member 30 can be a conical coil spring positioned in a recess 11 formed in an inner wall of the tank case 10. The spring member 30 is arranged so that its load center can substantially match a gravity center of the pressure plate 31. A peripheral edge portion of the flexile member 40 is welded to a welding portion 13 of the tank case 10. The flexible member 40 and the tank case 10 constitute a sealed space except for the ink supply port 60, i.e., an ink containing chamber R.

A shape of the center of the flexible member 40 is defined by the pressure plate 31, which is a flat plate support member, and the peripheral edge portion of the flexible member 40 can be deformed. For the flexible member 40, its center is formed beforehand to be convex, and its sectional shape is nearly trapezoidal. As described below, the flexile member 40 can be deformed according to a change of an ink amount or pressure fluctuation in the ink containing chamber R. In this case, a peripheral edge portion of the flexile member 40 is flexibly deformed, and the center of the flexile member 40 moves left and right in FIG. 1 while maintaining a posture substantially parallel to the inner wall of the tank case 10. As the flexible member 40 is smoothly deformed (moved), no shocks are generated accompanying the deformation, and abnormal pressure fluctuation in the ink containing chamber R caused by such shock is prevented.

The spring member 30 of a compressing spring type presses the flexible member 40 in a left direction of FIG. 1 via the pressure plate 31. Its pressing force is applied in a direction of enlarging the ink containing chamber R to generate negative pressure in the ink containing chamber R. By the negative pressure, a negative pressure that enables an ink discharging operation of the recording head is applied to the ink in the recording head in equilibrium with a holding force of an ink meniscus formed in an ink discharge portion. In other words, in the ink containing chamber R, the negative pressure for enabling an ink discharging operation of the recording head is generated. FIG. 1 illustrates a state where the ink containing chamber R is almost completely filled with ink. In this state, the spring member 30 is in a compressed state, and proper negative pressure is generated in the ink containing chamber R.

The cap member 50 is attached to an opening of the tank case 10, and the flexible member 40 is protected by the cap member 50. The cap member 50 includes an atmosphere communication portion 51, and atmospheric pressure is set outside the ink containing chamber R in the tank case 10. Pressure in the ink containing chamber R is negative with respect to atmospheric pressure by a pressure amount corresponding to a pressing load of the spring member 30 to the pressure plate 31 and an area of a plane portion of the flexible member 40.

As illustrated in FIG. 1, ink 2 is supplied to the recording head and consumed when the ink containing chamber R is almost completely filled with the ink 2. In this case, the pressure plate 31 is moved right in FIG. 1 against the pressing force of the spring member 30. This movement is accompanied by deformation of the flexible member 40. The spring member 30 is compressed to increase its load. The negative pressure in the ink containing chamber R slightly increases as the load increases. When the ink 2 is further consumed, a volume of the ink containing chamber R is reduced until the pressure plate 31 comes into contact with an inner bottom surface of the tank case so that the plate cannot be displaced. The spring member 30 is a conical coil spring which prevents interferences among wires of the spring member 30 when compressed. The spring member 30 can be compressed by a width equal to a diameter of each wire. Since the spring member 30 is completely received into the recess 11 when completely compressed, the spring member 30 never interferes with displacement of the pressure plate 31.

Referring to FIGS. 4A to 4C, an ink movement mechanism near the ink supply port 60 will be described with respect to an environmental change of the ink tank 100 of the above mentioned configuration. Each of FIGS. 4A to 4C corresponds to a sectional diagram cut on the line 4A-4A of FIG. 2, and is an enlarged sectional diagram of the vicinity of the ink supply port 60.

According to the exemplary embodiment, the ink supply port 60 includes a supply port member 63. As illustrated in FIG. 4, the supply port 60 is an opening that supplies ink within the ink containing chamber ‘R’ to the recording head. The supply port member 63 is completely bonded to the tank case 10 to fix the capillary member 61. The sealing member 66 coupled to the cap member 65 is an elastic member made of an elastic material such as rubber, and its projection 68 is pressed to a plane portion of the supply port member 63. A repulsive force of the pressing is held by engaging claws 72 and 69 of a handle 67 to fix the cap member 65 to the tank case 10. The projection 68 is formed as a rib on a circumference at a position opposing the supply port 60 along the surroundings of the supply port 60, and a full surface of the rib is pressed to the supply port member 63 to cover the supply port 60 with the sealing member 66. The supply port 60 is covered and sealed with the sealing member 66. The ink tank 100 is brought into a distribution process in a state that the supply port 60 is covered with the sealing member 66. Accordingly, a space of the supply port 60 becomes a space (supply port space 70) sealed by the capillary member 61, the supply port member 63, and the sealing member 66. According to the exemplary embodiment, since the ink containing chamber R is almost completely filled with the ink 2, the capillary member 61 is also filled with the ink 2 by its capillary force. A feature of this configuration is that the ink holding amount of the capillary member 61 and the supply port space 70 are defined in a certain relation. A specific relation is as follows.

An ink amount, i.e., an ink volume (Vi), held in the capillary member 61, an air volume (V) of the supply port space 70, and a maximum volume (Vexp) when air expands in the supply port space 70 because of an environmental change in a distribution state of transportation or delivery, satisfy a following condition:

Vi≧Vexp−V (1)

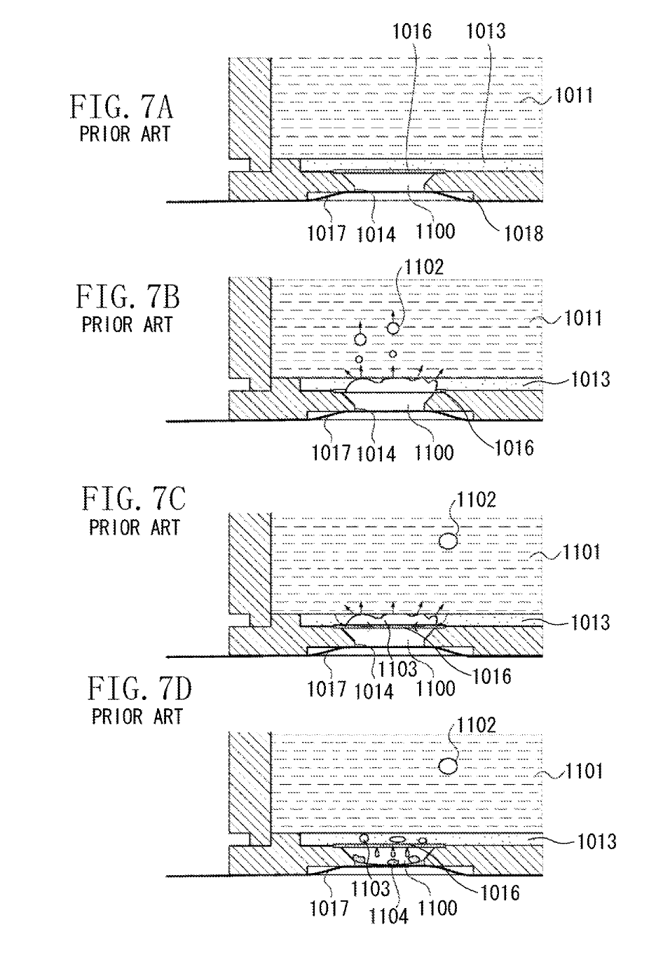

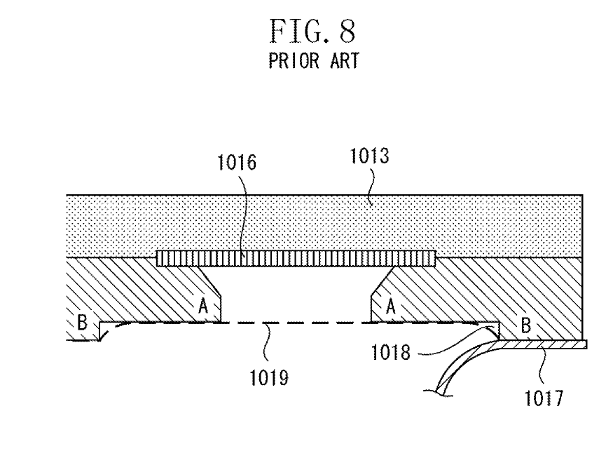

In the distribution of ink tanks, FIG. 4B illustrates a state where an environmental temperature rises or atmospheric pressure falls from the state of FIG. 4A. The air in the supply port space 70 expands because of a temperature increase or an atmospheric pressure reduction. As described above, the volume of the ink containing chamber R can be flexibly changed by the flexible member 40. Thus, the expanded air enters the capillary member 61 to push out the ink therefrom to the ink containing chamber R. An ink volume, i.e., an ink amount Vi, held by the capillary member 61 is set to be, as apparent from the conditional equation (1), equal to or more than a value obtained by subtracting the air volume of the supply port space 70 from the maximum volume Vexp when the air expands. Accordingly, the expanded air volume is less than the ink amount held in the capillary member 61, and the expanded air stays in the capillary member 61 as illustrated in FIG. 4B. When the conditional equation (1) is not satisfied, since the capillary member 61 is thin and the ink containing chamber R for directly containing the ink 2 is present directly above the vicinity of the supply port 60, the expanded air moves in the ink containing chamber R and to the upper part of the ink containing chamber R. When the expanded air shrinks, the volume of the air moved to the upper part of the ink containing chamber R is reduced in the ink containing chamber R. At this time, the expanded air in the capillary member 61 shrinks to return into the supply port space 70. Ink of a volume equal to that of air returned from the capillary member 61 into the supply port space 70 flows from the ink containing chamber R into the capillary member 61 to push out the ink that is present in the capillary member 61 before the air expansion. The ink of the pushed-out volume drips into the supply port space 70. Since a surface of the capillary member 61 on the supply port 60 side is open to the supply port space 70, a capillary force of the capillary member 61 is lower than an internal capillary force. As a result, the air that has entered the capillary member 61 and the air in the supply port space 70 are never separated from each other unlike the case of FIG. 7C.

FIG. 4C illustrates a case where the environmental temperature or the atmospheric pressure has returned from the state of FIG. 4B to the initial state of FIG. 4A. This time, conversely, a temperature reduction or an atmospheric pressure increase causes shrinkage of the air in the supply port space 70. The air in the supply port space 70 and the air in the capillary member 61 integrally shrink as they are not separated from each other. Accordingly, as indicated by an arrow of FIG. 4C, the ink 2 is drawn from the ink containing chamber R to increase the ink holding amount in the capillary member 61 again. The air volume expanded from the state of FIG. 4A to that of FIG. 4B is equal to the air volume shrunk from the state of FIG. 4B to the state 4C. Accordingly, when the temperature or the atmospheric pressure returns to the initial state, the state of the supply port space 70 returns to the state of FIG. 4A. Thus, a temperature change or an atmospheric pressure change causes no ink dripping into the supply port space.

Environmental changes that cause air expansion include a temperature increase and an atmospheric pressure reduction. Generally, an expansion amount caused by the atmospheric pressure reduction is larger than that caused by the temperature increase. For example, when a cap member is installed at 25° C. in a manufacturing process, if the temperature increases up to 60° C. during transportation, delivery, or distribution process, an expansion volume increases about 1.12 times. However, when the tank is used on a highland of 4000 m or more, atmospheric pressure is about 0.6 atm. Therefore, an air expansion volume increases about 1.67 times in this state, and the expansion volume due to atmospheric pressure is much greater than the volume due to the temperature change.

Atmospheric pressure which is lowest in an actual environment where the ink tank can be placed is, for example, as follows, presuming that atmospheric pressure in an almost normal state is 1 atm.:

| Atmospheric pressure | Environment |
|---|---|
| 0.9 atm | Used on a flat land. Not moved. |
| 0.7 atm | Transported by plane. |
| 0.6 atm | Used on a highland of 4000 m or more |
| | (e.g., Bolivia or Tibet) |

In order to satisfy specifications of the ink tank 100 in any states of use, only a situation where no ink dripping occurs at 0.6 atm. has to be taken into consideration. In this case, an air expansion volume is 1.67 times larger. Accordingly, volumes Vi and V are set to satisfy the following equation where V is a volume of the supply port space 70:

Vi≧Vexp−V=1.67*V−V=0.67*V

By setting an ink holding volume Vi of the capillary member 61, an air volume V of the supply port space 70, and a maximum volume Vexp of expanded air in such a relation, no ink dripping occurs in an atmospheric change up to 0.6 atm., as environmental fluctuation of the ink tank 100. In the case where used only on a flat land, an expansion volume is 1.11 times larger at atmospheric pressure 0.9 atm. on the flat land. Since an expansion volume of 1.12 times when the environmental temperature increases to 60° C. is larger, environmental temperature changes are first to be dealt with. In other words, volumes Vi and V are set to satisfy the following equation:

Vi≧Vexp−V=1.12*V−V=0.12*V

Since ink dripping into the supply port space 70 may occur due to not only environmental changes but also dropping or vibration, a smaller volume of the supply port space 70 is better. Thus, after the volume V of the supply port space 70 is reduced as much as possible, an ink holding amount Vi of the capillary member 61 with respect to the environmental change amount as above presumed is decided.

A case where the air of the supply port space 70 shrinks when the environmental temperature drops or the atmospheric pressure rises will be described below.

The air shrinking state is a state changed from FIG. 4B to FIG. 4C. A case will be described where the air expanded in the capillary member 61 shrinks. When the expanded air breaks away from the supply port space 70 to be captured in the capillary member 61 while it is not communicated with the supply port space 70, the expanded air present in the capillary member 61 shrinks itself therein. At this time, ink of a volume equal to the volume of shrunk and reduced air is drawn from the ink containing chamber R into the capillary member 61. In addition, the air in the supply port space 70 shrinks. Ink of a volume equal to the volume of the shrunk air in the supply port space 70 is pushed out of the ink containing chamber R to the capillary member 61. The ink thus pushed into the capillary member 61 exceeds an ink holding force thereof so that the ink drips into the supply port space 70.

However, if the expanded air stays in the capillary member 61 in a communicating state with the supply port space 70 (while the air has expanded, a certain amount of ink is still present in the capillary member 61), the air of the supply port space 70 and the air of the capillary member 61 shrink in a communicating state with each other. Ink of a volume equal to the shrunk volume is pushed out of the ink containing chamber R into the capillary member 61. Since the ink amount Vi held in the capillary member 61, the air volume V of the supply port space 70, and the maximum volume Vexp when the air expands are defined as in the case of the conditional equation (1), the ink pushed out of the ink containing chamber R never drips into the supply port space 70. In other words, even when the air expands, the amount of ink to satisfy the conditional equation (1) has to be held in the capillary member 61. Since the capillary member 61 has a capillary force, when ink is injected into the ink tank 100, the ink is held up to the surface of the capillary member 61 while no air is held in the capillary member 61. It is indeed possible to hold closed air in the capillary member 61 by ink. According to the exemplary embodiment, however, ink has to be held in the capillary member 61 to satisfy the conditional equation (1). When air communicating with the supply port space 70 is held in the capillary member 61, ink dripping can be suppressed by holding an ink amount to satisfy the conditional equation (1).

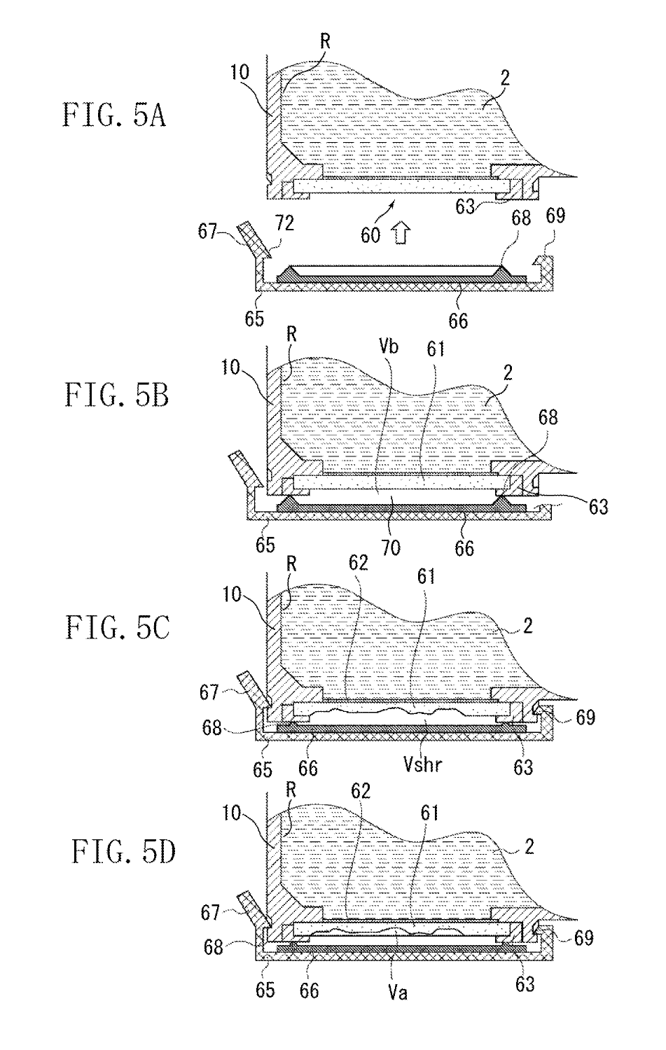

FIG. 5A is a sectional diagram illustrating a case of installing the cap member 65. The cap member 65 is fixed to the tank case 10 in an arrow direction of the drawing. FIG. 5B illustrates a state where a tip of the projection 68 of the sealing member 66 touches the supply port member 63. The cap member 65 is not engaged with the tank case 10, and the tip of the projection 68 is only in contact with the supply port member 63 but is not crushed. Subsequently, as illustrated in FIG. 5C, the lever 67 as a handle and the engaging claw 69 are engaged with the tank case 10. As a result, the tip of the projection 68 is crushed to seal the cap member 65 and the tank case 10. The engaging claw 72 to engage the tank case 10 is also disposed in a part of the lever 67. By mutual interaction of the two engaging claws 69 and 72 disposed in the cap member 65 and facing each other across the supply port 60 at the time of installing the capo member 65, the projection 68 is pushed to the tank case 10 side. This operation is carried out to fix the cap member 65 and surely seal the supply port space 70. The supply port 60 is sandwiched by a plurality of engaging claws, and the projection 68 of the sealing member 66 crushes the supply port 60. At this time, the sealed space of the supply port space 70 is compressed by an amount equal to the crushed amount. An amount of air equal to the compressed volume is pushed into the capillary member 61. Accordingly, the air is held in the capillary member 61 in a state that the cap member 65 is installed. The following condition is established, where Vb is an air volume in the supply port space (including the air volume held in the capillary member 61) as illustrated in FIG. 5B, Vshr is a minimum air volume after an environmental change likely to occur during transportation causes shrinkage as illustrated in FIG. 5C, and Va is an air volume held in the capillary member 61 as shown in FIG. 5D:

Va≧Vb−Vshr (2)

Thus, ink dripping can be suppressed even when the temperature drops or the atmospheric pressure rises. It is useful to set a compression amount Va at the time of installing the cap member 65, which is decided by tip heights of the lever 67 and the engaging claw 69 and the projection 68, to be equal to or more than an estimated air shrinkage amount volume Vb−Vshr of the supply port space 70.

A minimum temperature in an actual environment where an ink tank 100 is placed is about −30° C. In this case, an air volume shrinks 0.89 times (when a sudden temperature change occurs). When the temperature gradually changes to −30° C., the ink freezes to disable volume changing of the ink containing chamber R, and an air volume may not shrink 0.89 times even at the temperature −30° C. An atmospheric pressure increase is 1.1 atm. In this case, an air shrinkage volume is 0.91 times. Accordingly, since a volume change when the air shrinks is smaller than that when the air expands, only air expansion has to be taken into consideration to deal with ink dripping from the ink supply port 60. Needless to say, measures should be taken against both air expansion and air shrinkage.

### Second Exemplary Embodiment

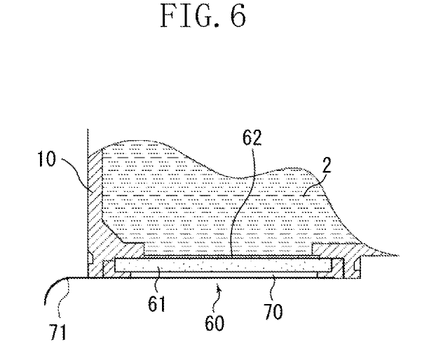

FIG. 6 is a sectional diagram of an ink tank according to a second exemplary embodiment of the present invention.

According to the second exemplary embodiment, a cap member is a film member 71. If it is the cap member that seals the supply port space 70, the elastic sealing member is coupled to the highly rigid cap member. According to the second exemplary embodiment, however, the supply port space 70 is sealed only with the film member 71 having an adhesive layer. According to the second exemplary embodiment, as in the case of the first exemplary embodiment, it may be configured such that the conditional equation (1) or (2) is satisfied. According to the second exemplary embodiment, manufacturing costs can be reduced since the simply configured film member 71 can be used.

As in the case of the first exemplary embodiment, the present exemplary embodiment provides an ink dripping suppression effect when air expands in the supply port 60 when a temperature increases or an atmospheric pressure is reduced in the ink tank. However, to deal with a temperature reduction or an atmospheric pressure increase caused by environmental fluctuation, in an ink tank manufacturing process, the film member 71 has to be stuck under an environment of high pressure that is higher than 1 atm. By sticking the film member 71 to the supply port 60 in this manner, when normal atmospheric pressure is restored at the time of shipping, air expands in the supply port space 70 to enable holding of air in the capillary member 61. As a result, a similar effect can be achieved for ink dripping.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-092028 filed Mar. 30, 2007, which is hereby incorporated by reference herein in its entirety.

What is claimed is:

1. An ink tank comprising:
an ink containing chamber configured to directly contain ink;
a supply port configured to supply the ink from the ink containing chamber to a recording head;
a capillary member disposed in the supply port and adapted to hold the ink; and
a sealing member configured to cover the supply port,
wherein an air volume (V) of a space constituted by the capillary member and the sealing member, an ink volume (Vi) held by the capillary member, and a maximum volume (Vexp) when air expands in the space accompanying environmental fluctuation in the ink tank, satisfy the following condition:
Vi≧Vexp−V.

2. The ink tank according to claim 1, wherein the sealing member includes an elastic member sealing the supply port, and a cap member holding the elastic member and pressing the elastic member to the supply port to seal the supply port.

3. The ink tank according to claim 2, wherein the cap member presses the elastic member to the supply port by a plurality of engaging claws to seal the supply port.

4. The ink tank according to claim 1, wherein the sealing member is a film member sealing the supply port.

5. The ink tank according to claim 1, wherein the capillary member is held in the supply port, and a meniscus forming member is disposed between the capillary member and the ink contained in the ink containing chamber to form a meniscus supplying the ink to the recording head.

6. An ink tank comprising:
an ink containing chamber configured to directly contain ink;
a supply port configured to supply the ink from the ink containing chamber to a recording head;
a capillary member disposed in the supply port to hold the ink; and
a sealing member configured to cover the supply port,
wherein an air volume (Vb) of a space constituted by the capillary member and the sealing member, an air volume (Va) held by the capillary member, and a minimum air volume (Vshr) when air shrinks in the space accompanying environmental fluctuation of the ink tank, satisfy the following condition, when the sealing member is in contact with the supply port:
Va≧Vb−Vshr.

7. A method for manufacturing an ink tank which includes an ink containing chamber configured to directly contain ink, a supply port configured to supply the ink from the ink containing chamber to a recording head, a capillary member disposed in the supply port to hold the ink, and a sealing member configured to cover the supply port, the method comprising:
covering the supply port with the sealing member under an environment of pressure higher than 1 atm, so that one of the following conditions is satisfied:
in a manner that an air volume (V) of a space constituted by the capillary member and the sealing member, an ink volume (Vi) held by the capillary member, and a maximum volume (Vexp) when air expands in the space accompanying environmental fluctuation of the ink tank, satisfy Vi≧Vexp−V, or
in a manner that an air volume (Vb) of a space constituted by the capillary member and the sealing member, an air volume (Va) held by the capillary member, and a minimum air volume (Vshr) when air shrinks in the space accompanying environmental fluctuation of the ink tank, when the sealing member is in contact with the supply port, satisfy Va≧Vb−Vshr.
